(19) United States
(12) Patent Application Publication
(10) Pub. No.: US 2026/0082270 A1
(43) Pub. Date: Mar. 19, 2026

(54) TRANSMITTER SCHEDULER IN WIRELESS COMMUNICATION

(71) Applicant: TP-LINK SYSTEMS, INC., Irvine, CA (US)

(72) Inventors: Tianan Ma, San Jose, CA (US); Sonali Bagchi, San Jose, CA (US)

(73) Assignee: TP-LINK SYSTEMS, INC., Irvine, CA (US)

(21) Appl. No.: 18/885,878

(22) Filed: Sep. 16, 2024

(51) Int. Cl. H04W 28/06; H04W 74/04; H04W 84/12

(52) U.S. Cl. CPC H04W 28/06; H04W 74/04; H04W 84/12

(57) ABSTRACT

In some embodiments, in response to a transmission opportunity, an apparatus determines a total aggregated data unit length and issue a transmit start command to include the total aggregated data unit length. The total aggregated data unit length may be determined based on the total number of data bytes to be transmitted, a maximum number of media access control protocol data units, or an allowed transmission time. The apparatus subsequently aggregates the data units from a transmission queue and transmits data units as they are aggregated. In an alternative embodiment, when an apparatus is close to being permitted to transmit, the apparatus pre-scans the data units from a transmission queue by aggregating the data units, and determines a total aggregated data unit length based on the aggregated data units. The apparatus subsequently transmits a wireless frame including the aggregated data units.

### FIELD

This technology relates to wireless communication network, and more particularly to systems and methods for media access control.

### BACKGROUND

Wireless local area network (WLAN) protocols, such as Institute for Electrical and Electronics Engineers (IEEE) 802.11, allow for various devices (stations) to communicate with each other in a wireless communication network. Whereas the protocols specify the signaling in over the air (OTA) medium, many underlying implementation details in each device are left to the device manufacturers. For example, when a transmission opportunity (TXOP) becomes available to a device wishing to transmit data, the device may need to transmit the transmission data within a limited amount of time as allowed under a given wireless protocol. As such, there is a desire for the device to prepare the data to be transmitted in less computation time.

### SUMMARY

The present disclosure relates to techniques for efficient management of aggregated data units in wireless communication. In an embodiment, the techniques provide an apparatus for communication in a wireless network, the apparatus comprising a media access control (MAC) transmitter scheduler configured to perform one or more operations comprising, in response to determining that a transmission opportunity (TXOP) is available: determining a total aggregated MAC protocol data unit (MPDU) length based at least on a total number of data bytes to transmit and an MPDU size; transmitting a transmission (TX) start command using the total aggregated MPDU length; aggregating a plurality of MAC service data units (MSDUs) to determine one or more MPDUs to be transmitted, wherein a total length of the one or more MPDUs is about to reach the total aggregated MPDU length; determining a frame including the one or more MPDUs to be transmitted and a padding such that a length of the frame equals the total aggregated MPDU length; and transmitting a TX command to transmit the frame within an allowed time from when the TXOP is available.

In an embodiment, the techniques provide a method for communicating in a wireless network, the method comprising, at a media access control (MAC) transmitter scheduler, in response to determining that a transmission opportunity (TXOP) is available: determining a total aggregated MAC protocol data unit (MPDU) length based at least on a total number of data bytes to transmit and an MPDU size; transmitting a transmission (TX) start command using the total aggregated MPDU length; aggregating a plurality of MAC service data units (MSDUs) to determine one or more MPDUs to be transmitted, wherein a total length of the one or more MPDUs is about to reach the total aggregated MPDU length; determining a frame including the one or more MPDUs to be transmitted and a padding such that a length of the frame equals the total aggregated MPDU length; and transmitting a TX command to transmit the frame within an allowed time from when the TXOP is available.

In an embodiment, the techniques provide an apparatus for communication in a wireless network, the apparatus comprising a media access control (MAC) transmitter scheduler configured to perform one or more operations comprising, in response to determining that a transmission opportunity (TXOP) is available: determining a total aggregated MAC protocol data unit (MPDU) length based at least on an allocated transmission time; transmitting a transmission (TX) start command using the total aggregated MPDU length; aggregating a plurality of MAC service data units (MSDUs) to determine one or more MPDUs to be transmitted, wherein a total length of the one or more MPDUs is about to reach the total aggregated MPDU length; determining a frame including the one or more MPDUs to be transmitted and a padding such that a length of the frame equals the total aggregated MPDU length; and transmitting a TX command to transmit the frame within the allocated transmission time.

In an embodiment, the techniques provide a method for communicating in a wireless network, the method comprising, at a media access control (MAC) transmitter scheduler, in response to determining that a transmission opportunity (TXOP) is available: determining a total aggregated MAC protocol data unit (MPDU) length based at least on an allocated transmission time; transmitting a transmission (TX) start command using the total aggregated MPDU length; aggregating a plurality of MAC service data units (MSDUs) to determine one or more MPDUs to be transmitted, wherein a total length of the one or more MPDUs is about to reach the total aggregated MPDU length; determining a frame including the one or more MPDUs to be transmitted and a padding such that a length of the frame equals the total aggregated MPDU length; and transmitting a TX command to transmit the frame within the allocated transmission time.

In an embodiment, the techniques provide an apparatus for communication in a wireless network, the apparatus comprising a media access control (MAC) transmitter scheduler configured to perform one or more operations comprising: in response to or after starting a backoff counter, at a first time: (1) aggregating a plurality of media access control (MAC) service data units (MSDUs) to determine one or more MPDUs to be transmitted; and determining a total aggregated MPDU length based on respective lengths of the one or more MPDUs to be transmitted. The one or more operations further comprise: in response to determining that a transmission opportunity (TXOP) is available, at a second time after the first time: (1) transmitting a transmission (TX) start command using the total aggregated MPDU length; (2) determining a frame including the one or more MPDUs to be transmitted; and (3) transmitting a TX command to transmit the frame within an allocated transmission time.

In an embodiment, the techniques provide a method for communicating in a wireless network, the method comprising, at a media access control (MAC) transmitter scheduler: in response to or after starting a backoff counter, at a first time: (1) aggregating a plurality of media access control (MAC) service data units (MSDUs) to determine one or more MPDUs to be transmitted; and determining a total aggregated MPDU length based on respective lengths of the one or more MPDUs to be transmitted. The method further comprises: in response to determining that a transmission opportunity (TXOP) is available, at a second time after the first time: (1) transmitting a transmission (TX) start command using the total aggregated MPDU length; (2) determining a frame including the one or more MPDUs to be transmitted; and (3) transmitting a TX command to transmit the frame within an allocated transmission time.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 illustrates a wireless communication network, according to some embodiments.

FIG. 2A is a schematic diagram showing a linked list of data units to be transmitted at a device, according to some embodiments.

FIG. 2B is a schematic diagram of aggregated data units at different levels, according to some embodiments.

FIGS. 3-5 are data flow diagrams of variations of example operations for transmitting a wireless frame according to some embodiments.

FIG. 6 is a schematic diagram of a MAC transmitter scheduler, according to some embodiments.

FIG. 7 is a schematic diagram of a series of operations that may be executed in the MAC transmitter scheduler in FIG. 6, according to some embodiments.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. It should be further appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect. In the present disclosure, the MAC and the MAC layer may be interchangeable. The PHY and the PHY layer may be interchangeable. The transmission and TX (or Tx) may be interchangeable.

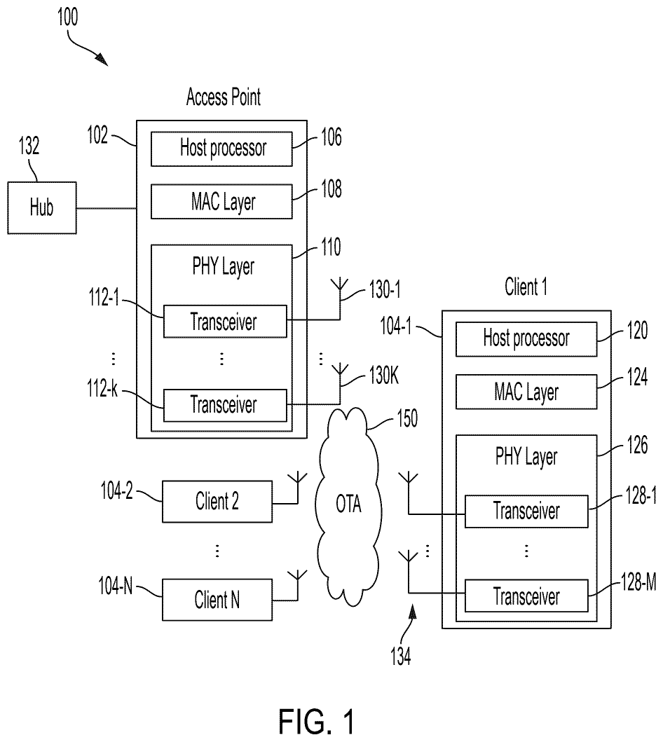

FIG. 1 illustrates a wireless communication network, according to some embodiments. In some embodiments, a wireless communication network 100 (e.g., WLAN) may facilitate communications between one or more access point (AP) device (e.g., 102) and one or more client devices (e.g., 104-1, 104-2, . . . 104-N). Each of the AP and client devices may be configured to receive or transmit frames (packets) from/to another device (e.g., AP or client devices) via over the air (OTA) medium (e.g., 150). These communication devices may be communicating with each other in a communication protocol, e.g., IEEE 802.11, or other suitable wireless protocols.

As shown in FIG. 1, AP device 102 may include one or more antennas (e.g., 130-1, . . . 130-K) configured to transmit or receive radio frequency (RF) signals to/from other devices in the wireless communication network 100. AP device 102 may include a PHY layer 110, a MAC layer 108, and a host processor 106, which are configured to generate or process RF signals in lower to upper network layers, respectively. For example, PHY 110 may be configured to implement physical layer functions. PHY 110 may also include one or more transceivers (e.g., 112-1, . . . 112-K) configured to convert between baseband signals and RF signals, where RF signals are transmitted or received via the one or more antennas, e.g., 130-1, . . . 130-K. In a non-limiting example, in 802.11, PHY 110 may be configured to receive wireless frames, e.g., MPDU (MAC protocol data unit) from the MAC, remove the preamble and PHY header and extract the baseband signals. Similarly, PHY 110 may add the preamble and the PHY header to the baseband signals to generate wireless frames (packets), e.g., MPDUs, for passing to the MAC layer.

In FIG. 1, MAC 108 may be configured to implement MAC layer functions including processing frames (packets) received from the PHY layer and converting to data frames for upper layer(s), or vice versa. For example, in 802.11, MAC 108 may extract MSDUs (MAC service data unit) payload encapsulated in the frame body of MPDUs for the upper layers, where MPDUs are received from the PHY layer. Similarly, MAC 108 may receive MSDUs from upper layers and convert them to MPDUs for the PHY layer. Host processor 106 may be coupled to MAC 108 and PHY 110 to process data via respective layers. Host processor 106 may also be configured to implement one or more applications and transmit/receive data to/from MAC 108.

As shown in FIG. 1, each of the components, e.g., host processor 106, MAC 108, PHY 110, as well as transceivers (112-1, . . . 112-K) may include circuitry, e.g., one or more integrated circuits (ICs). Thus, one or more functions of the MAC and PHY layers may be implemented in hardware. Alternatively, and/or additionally, one or more functions of the MAC and PHY layers may be implemented in software, e.g., via executing programing instructions (e.g., stored in memory). For example, each of MAC 108 and PHY 110 may include one or more processors, e.g., CPUs, to execute programming instructions in a memory.

With further reference to FIG. 1, AP device 102 may be connected to a hub 132 (e.g., a wired router, a modem) which provides the Internet services (e.g., via an ISP). AP device 102 may provide Internet, via hub 132, to one or more client devices (e.g., 104-1, 104-2, . . . 104-N) that are connected to the AP device wirelessly, e.g., via OTA medium 150. Each of the client devices may have a similar configuration as the AP device 102. For example, client device 104-1 may include a host processor 120, a MAC layer 124, a PHY layer 126.

Similar to AP device 102, a client device (e.g., 104-1, 104-2, . . . 104-N) may include one or more antennas (e.g., 134) configured to transmit or receive RF signals to/from other devices in the wireless communication network 100. PHY layer 126, MAC layer 124, and host processor 120 may be configured to generate or process RF signals in lower to upper network layers, respectively. For example, PHY layer 126 may be configured to implement physical layer functions. PHY layer 126 may include one or more transceivers (e.g., 128-1, . . . 128-M) configured to convert between baseband signals and RF signals, where RF signals are transmitted or received via the one or more antennas 134. In a non-limiting example, in 802.11, PHY layer 126 may receive wireless frames, e.g., MPDUs from MAC layer 124, remove the preamble and PHY header and extract the baseband signals. Similarly, PHY 126 may add the preamble and the PHY header to the baseband signals to generate wireless frames (packets), e.g., MPDUs, for passing to MAC layer 124.

In FIG. 1, MAC layer 124 may be configured to implement MAC layer functions including processing frames (packets) received from the PHY layer and converting to data frames for upper layer(s), or vice versa. For example, in 802.11, the MAC layer may extract MSDUs payload encapsulated in the frame body of MPDUs for the upper layers, where MPDUs are received from the PHY layer. Similarly, the MAC layer may receive MSDUs from the upper layers and convert them to MPDUs for the PHY layer. Host processor 120 may be coupled to MAC layer 124 and PHY layer 126 to process data via respective layers. Host processor 120 may also be configured to implement one or more applications and transmit/receive data to/from MAC layer 124.

Similar to AP device 102, each of the components in a client device, e.g., host processor 120, MAC layer 124, PHY layer 126, as well as transceivers (128-1, . . . 128-M) may include circuitry, e.g., one or more integrated circuits (ICs). Thus, one or more functions of MAC and PHY layers may be implemented in hardware. Alternatively, and/or additionally, one or more functions of the MAC and PHY layers may be implemented in software, e.g., via executing programing instructions (e.g., stored in memory) by MAC layer 124, PHY layer 126, host processor 120, or any other suitable processors. Client devices 104-2, . . . 104-N may each have a similar configuration as client device 104-1. Although one AP device 102 is shown in FIG. 1, it is appreciated that there can be multiple AP devices in the wireless communication network 100. Further, any suitable number of client device may be possible as supported in current or later developed protocols.

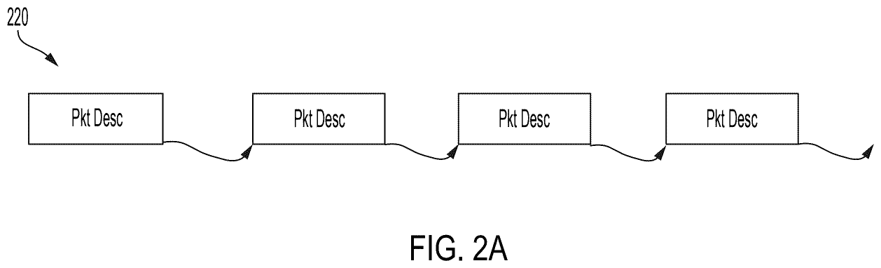

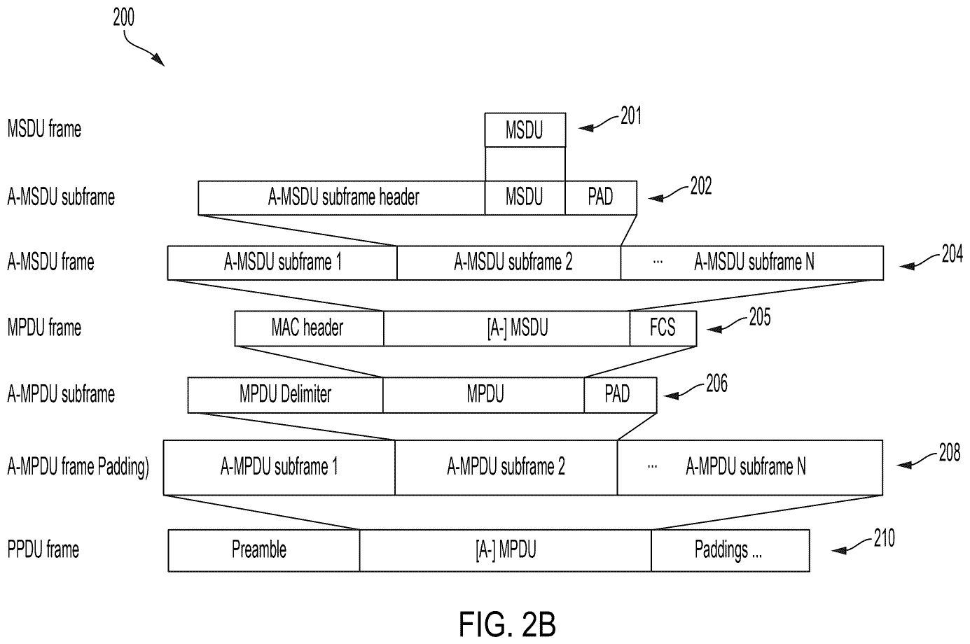

In some embodiments, a transmitter device, e.g., AP device 102 or client devices 104 may receive a plurality of data packets (data units) at the MAC layer for transmission to the wireless network. For example, the data units may be MSDUs received from an upper layer (e.g., network layer, host processor 106, 120 (FIG. 1)). FIG. 2A is a schematic diagram showing a linked list of data units to be transmitted at a device, according to some embodiments. Linked list 220 may be a linked list of descriptors of data units (e.g., MDSU descriptor) to be transmitted. A data unit descriptor (e.g., MSDU descriptor) may include a pointer to a memory location of the data unit and other information about the data unit. In some examples, MSDUs to be transmitted are received at the MAC layer (e.g., from an upper layer) while a linked list of MSDU descriptors is created. The linked list e.g., 220 may be accessed by the MAC layer to construct a wireless frame for transmission, for example, by aggregating the data units represented by the linked list.

FIG. 2B is a schematic diagram of aggregated data units, according to some embodiments. As shown, a data unit may be a data frame at different levels. For example, a data unit may be an MSDU frame (201). A data unit may be an MPDU frame (205), which is aggregated MSDUs. Aggregation of multiple data units may include grouping data units (e.g., MSDUs) to be transmitted into different MPDUs, each containing one or more MSDUs. The aggregation may further include grouping multiple MPDUs into an aggregated MPDU to fill up a frame. For example, MSDU 201, maybe the smallest data unit, which includes MSDU payload only. Multiple MSDUs may be aggregated into an aggregated MSDU (A-MSDU), e.g., A-MSDU frame 204 comprising multiple A-MSDU subframes 202 transmitted together in a wireless frame. An MSDU subframe 202 includes an A-MSDU subframe header and padding per MSDU. In a non-limiting example, an A-MSDU subframe header may include destination address (DA), source address (SA), and length of MSDU payload, whereas padding may include four-byte alignment or other suitable alignment. In some embodiments, an A-MSDU may be encapsulated in an MPDU payload, e.g., MPDU frame 205. As shown, an MPDU frame 205 may additionally include other information, such as MPDU header, and FCS (frame check sequence). Multiple A-MPDU subframes may also be aggregated into an aggregated MPDU, e.g., A-MPDU frame 208, where an A-MPDU subframe (e.g., 206) includes an MPDU frame 205 with added MPDU delimiter and padding. Aggregated MPDUs (e.g., A-MPDU frame 208) may be encapsulated into a PPDU frame with preamble and padding, such as PPDU frame 210.

In a wireless communication network, each device (e.g., any device 102, 104 in FIG. 1) may be a transmitter device, which needs to transmit data only when a transmission opportunity (TXOP) becomes available. However, the time that is available for a device to prepare all of the transmission data and other information about the transmission is limited. For example, under some wireless protocols, a transmitter device may be required to send a transmission time in the beginning of a transmission (e.g., in a L-SIG field following training fields) to tell the other non-recipient devices how much time to wait for the OTA medium to be idle while the transmission is in session. The transmission time may be associated with the amount of data to be transmitted, and thus, the length of data. To comply with the protocols or other requirements in wireless communication, a transmitter device may need to first transmit the length of data (e.g., total length of aggregated data units) before transmitting the data units. This may be particular challenging because calculating the total data length may require scanning and aggregating hundreds or thousands of data units first, and this process can be quite time consuming. In other words, a transmitter device may have limited amount of time to calculate the total data length at the beginning of transmission.

The inventors have recognized and acknowledged that existing systems often pre-determine the data to be transmitted before the transmission opportunity is available. For example, respective data units (transmission queues) for transmitting to different devices or respective data units for different levels of QoS may be pre-determined before the MAC determines which transmission queue is to be transmitted. In such configuration, the total length of aggregated data units may be calculated (from the pre-determined data units to be transmitted) before or at the time when TXOP is available.

These approaches in existing systems, however, may result in transmitting data that are obsolete or inadequate for an intended transmission when a particularly TXOP becomes available. For example, due to the dynamic changes of wireless channels (e.g., the conditions of the OTA medium) and devices (e.g., the capability of a receiver device), the actual data units that need to be transmitted or other signal information associated with a transmission cannot be determined until the moment at which the TXOP is ready. Thus, pre-calculating the transmission data or the total length thereof can result in unwanted data to be transmitted. Such inflexibility is a major drawback of the existing approaches.

Further, existing approaches often consume significant memory space and computing power because large amount of data need to be pre-calculated and stored in a memory. For example, in determining the total length of aggregated MPDUs (A-MPDU), the MAC of a transmitter device may scan all of the aggregated MPDUs to determine the length of each MPDU, and add the lengths of the MPDUs together. In determining the length of an MPDU, which may include aggregated MSDUs, the MAC may need to scan all of the MSDUs within the MPDU payload. The MAC may repeat the pre-calculation for all of the transmission queues (respectively for different receiver devices and QoS levels).

Accordingly, the inventors have developed technologies for managing the aggregated data units and determining the total aggregated data unit length. Aggregating data units, e.g., MSDUs, may include grouping multiple MSDUs in a transmission queue into different MPDUs. This grouping may depend on how many MSDUs may be allowed in an MPDU. For example, the MAC may determine how many MSDUs are grouped into an aggregated MSDU (A-MSDU, or an MPDU) based on the MPDU length and the lengths of the MSDUs. Determining the total aggregated data unit length may include adding respective lengths of the aggregated MPDUs once the MSDUs are aggregated. Alternatively, determining the total aggregated data unit length may include estimating the total aggregated data unit length without aggregating the data units.

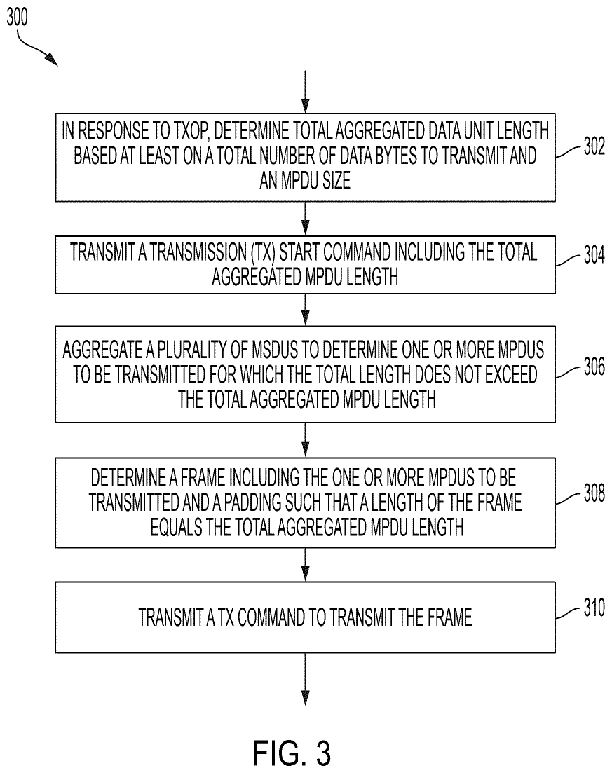

FIGS. 3-5 are data flow diagrams of variations of example operations for managing the aggregated data units and determining the total aggregated data unit length. These operations may transmit a wireless frame based on the total aggregated data unit length and aggregated data units. These operations may be implemented in the MAC layer of a transmitter device. For example, in FIG. 3, operation 300 may include: in response to determining that a TXOP is available, determining a total aggregated MPDU length based at least on a total number of data bytes to transmit and an MPDU size, at act 302. In this operation, the total aggregated data unit length can be quickly determined without aggregating the data units.

In some embodiments, the total number of data bytes to transmit may be known at the transmitter device. In such case, the total aggregated data unit length may be determined based on an estimated number of MPDUs that can fit into the total number of data bytes to transmit, where the MPDU size is considered. In some variations, headers and delimiters that need to be included in a wireless frame may also be considered. For example, given an MPDU size, when considering the MPDU delimiter, the MAC header and FCS in an MPDU frame (see 205 in FIG. 2), the total aggregated data unit length may be determined based on a maximum number of A-MPDU subframes (e.g., 206 in FIG. 2) that can fit into the total number of data bytes to transmit.

In some embodiments, the total number of data bytes to transmit may be configured by the device to be determined based on a maximum number of MPDUs multiplied by an MPDU size. The maximum number of MPDUs may be determined per wireless protocol. For example, in some protocols, the maximum number of MPDUs may be the BA (block acknowledgement) size, e.g., 64 or any other values supported by the protocols. For example, the BA size may be limited by both the transmitter device and the receiver device's capabilities. As such, in a non-limiting example, the total number of data bytes may be the maximum number of MPDUs (e.g., 64 or other suitable values)×S, where S is the MPDU size.

In some embodiments, the MPDU size may be a fixed size, including any of a maximum MDPU size, an average MPDU size, an average MSDU size (if A-MSDU is not allowed, in which case an MPDU may be a single MSDU), or any other fixed number. In non-limiting examples, the transmitter device may know that the data for transmission is largely video (e.g., based on given protocols at Ethernet layer), and thus, the maximum MSDU size may be used for determining the MPDU size. In other non-limiting examples, the data for transmission may largely be voice, and thus, smaller size MPDUs may be used to avoid loss of data packets as human ears are sensitive to data packet loss. In some variations, the MPDU size may be a pre-configured size, e.g., a constant value, changes according to a pattern or any other suitable value(s). For example, the pattern may include long-short-long-short (where long indicates a larger MDPU size and short indicates a smaller MPDU size), or any other suitable patterns.

In some embodiments, the total number of data bytes to transmit may be determined additionally based on a minimum MPDU start spacing (MMSS) between any two adjacent MPDUs. In non-limiting examples, MMSS may be 1 μs. In some examples, 1 μs may correspond to a data size in byte, e.g., 300 bytes (or other suitable number of bytes). Thus, in a wireless frame, there must be a minimum of 300 bytes (or other suitable number of bytes) between two adjacent MPDUs. Accordingly, the total number of data bytes may be determined based on M×(S+[MMSS])−[MMSS], where [MMSS] represents the equivalent number of bytes per MMSS depending on the modulation and coding scheme (MCS), for example. M stands for the maximum MPDU number provided per protocol, and S stands for the MPDU size.

With further reference to FIG. 3, operation 300 may include transmitting a transmission (TX) start command including the total aggregated MPDU length, at act 304. For example, a TX start command may be issued with a TX vector that includes the total aggregated MDPU length. Operation 300 may proceed with acts 306-310 to transmit the data while aggregating. This is further explained.

In FIG. 3, act 306 includes aggregating a plurality of MSDUs (e.g., data units represented by linked list 220 in FIG. 2A) to determine one or more MPDUs to be transmitted, for which a total length does not exceed the total aggregated MPDU length determined in act 302. In aggregating the data units, act 306 aggregates multiple MSDUs into an MDPU (when A-MSDU is allowed per protocol) up to the MPDU size, and aggregates multiple MPDUs up to the total aggregated MPDU length. The MAC calculates the accumulated length of the aggregated data units while aggregating, until no additional MPDU can be fitted into the total aggregated MPDU length (as determined in act 302). In such manner, the accumulated length of the aggregated data units must not exceed the total aggregated MPDU length as previously determined.

With further reference to FIG. 3, operation 300 includes determining a frame including the one or more MPDUs to be transmitted and a padding such that a length of the frame equals the total aggregated MPDU length, at act 308. Subsequently, the one or more MPDUs to be transmitted are transmitted, at act 310. This may be performed in response to a TX end command, in some examples.

In some examples, padding may be performed at various levels. For example, in additional to padding in act 308, when aggregating MSDUs into one or more MPDUs, an MPDU frame (e.g., A-MPDU subframe, shown as 206 in FIG. 2) may include a padding such that the length of the MPDU frame equals the MPDU size (e.g., the maximum MPDU size or the average MDPU size).

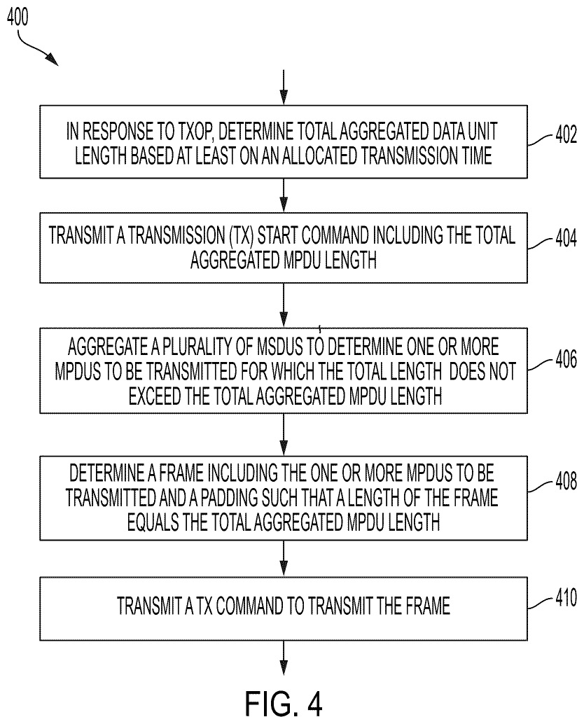

FIG. 4 shows operation 400 which is a variation of operation 300 in FIG. 3. In some embodiments, operation 400 may be similar to operation 300 (in FIG. 3) with a difference being that act 402 in operation 400 determines the total aggregated data unit length based at least on an allocated transmission time as opposed to the total number of bytes to transmit as in act 302 of operation 300. In act 402, in some examples, the allocated transmission time may be determined by a given wireless protocol, and indicates the time duration in which a transmitter device is allowed to transmit data after gaining an TXOP.

In some examples, the relationship between the allocated transmission time and the total aggregated data unit length may be represented by an inverse of a function that may be provided in a given protocol (or a vender). For example, a function TXTIME=f (PSDU_LENGTH) may be provided in certain IEEE 802.11 protocols. Thus, the total aggregated data unit length may be f⁻¹(allocated transmission time).

Additionally, and/or alternatively, the total aggregated MAC protocol data unit (MPDU) length may be determined additionally based on a modulation and coding scheme (MCS) and bandwidth (BW) associated with the TXOP. For example, when BW is high, the total aggregated data unit length may also increase. Similarly, when coding rate (which may be part of an MCS index matrix) increases, the total aggregated data unit length may increase because for the same allocated transmission time, more data may be transmitted due to higher coding rate.

Other acts in operation 400 with like reference numerals to those in operation 300 (FIG. 3) may also be implemented in a similar manner. For example, acts 404-410 are performed in a similar manner as acts 304-310 are performed (in FIG. 3), respectively, and descriptions of these acts are not repeated herein. Similarly, additional padding may be performed. For example, when aggregating MSDUs into one or more MPDUs, an MPDU frame (e.g., A-MPDU subframe, shown as 206 in FIG. 2) may include a padding such that the length of the MPDU frame equals the MPDU size, such as the maximum MPDU size or the average MDPU size etc.

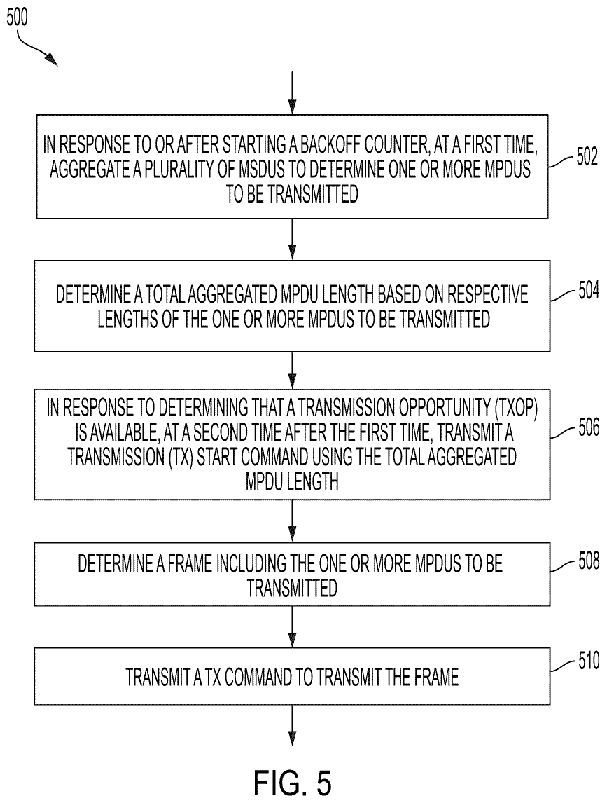

FIG. 5 shows operation 500 in which the total aggregated data unit length may be determined based on a pre-scanning of the plurality of MSDUs shortly before the TXOP is available. For example, operation 500 may include: in response to or after starting a backoff counter, at a first time, performing pre-scanning acts including: (1) aggregating a plurality of MSDUs to determine one or more MPDUs to be transmitted, at act 502; and (2) determining a total aggregated MPDU length based on respective lengths of the one or more MPDUs to be transmitted, at act 504. In comparison to operations 300 (FIGS. 3) and 400 (FIG. 4), pre-scanning (or aggregation) is performed in operation 500 in order to determine the total aggregated MPDU length.

With further reference to FIG. 5, operation 500 may perform acts (e.g., acts 506-510) at a second time at or after the TXOP is available. For example, act 506 includes transmitting a transmission (TX) start command including the total aggregated MPDU length. Similar to acts 304, 404, a TX start command may be issued with a TX vector that includes the total aggregated MDPU length. Act 508 may include determining a frame including the one or more MPDUs to be transmitted, such as the aggregated MPDUs from act 502. Further, act 510 may include transmitting a TX command to transmit the frame, similar to acts 310, 410, in response to a TX end command.

In some embodiments, acts 502 and 504 are performed only on the particular data units that are likely to be transmitted such that the subsequently aggregated data units to be transmitted would unlikely to be obsolete as in existing systems, at the time TXOP is available. This can be done by pre-scanning the MSDUs (in act 502) in a particular transmission queue at a time close to when the transmission queue is transmitted, such as upon the start of the backoff counter for that particular transmission queue, or when the backoff counter is close to expiration, e.g., two or fewer slot times intervals (e.g., slotTime as defined in the IEEE 802.11 protocols) before the backoff counter expires. The rationale behind this configuration is to select the transmission queue as close as the queue is about to be transmitted, and thus, no pre-calculations for other transmission queues need to be performed.

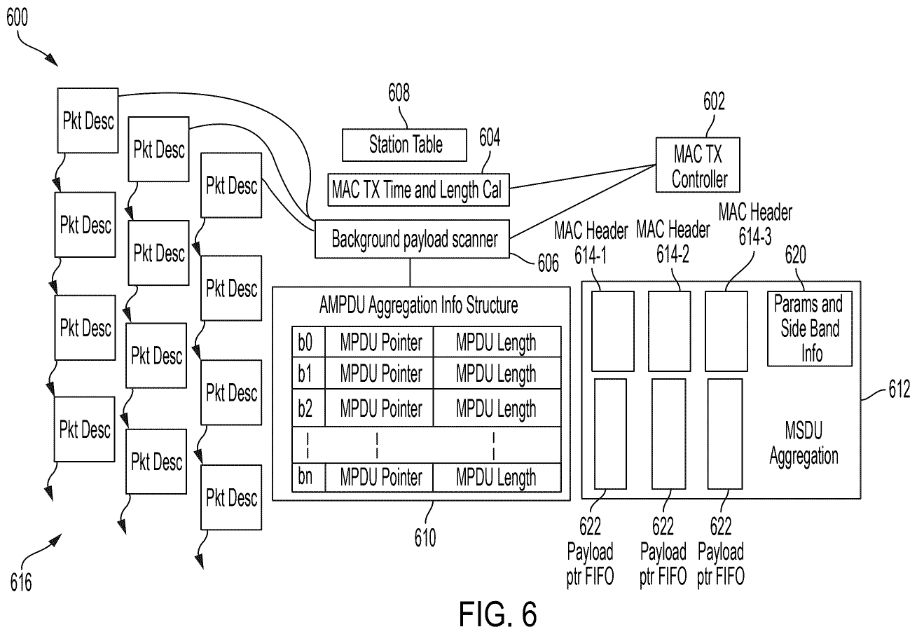

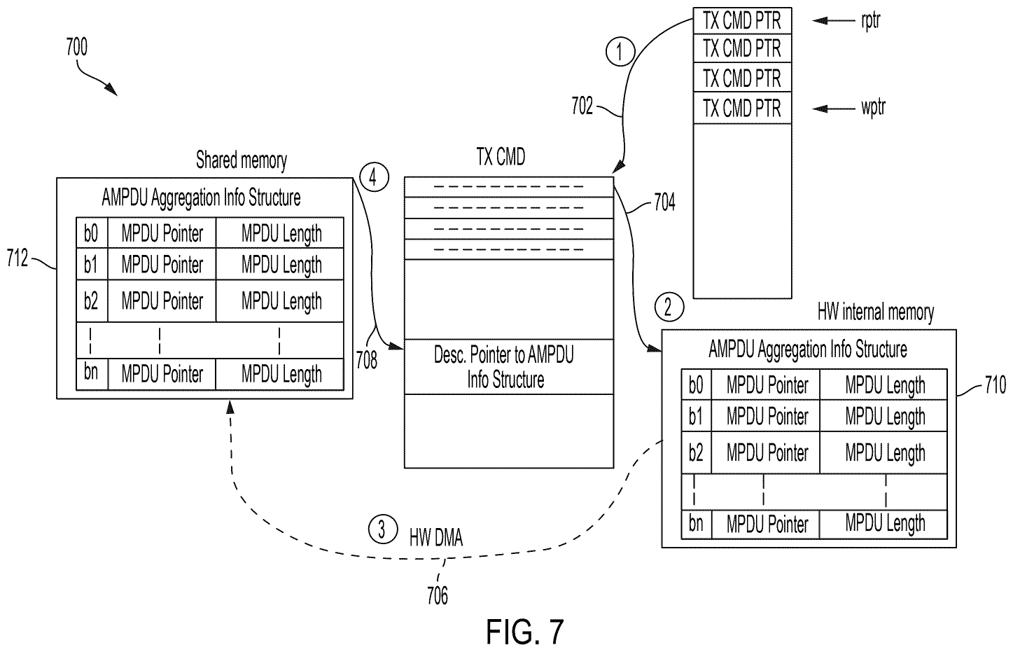

The embodiments described in FIGS. 3-5 are advantages over existing systems in that the data units are aggregated only when a device is permitted to transmit (when TXOP is available) or when the device is close to being permitted to transmit. This enables flexibility in aggregating only data units that will be transmitted (often determined only when TXOP is available). The advantages also include storage saving because there is no need to pre-calculate the data units and store the results for all of the transmission queues as in existing systems. These advantages can further be illustrated in FIGS. 6-7.

FIG. 6 is a schematic diagram of a MAC transmitter (TX) scheduler, according to some embodiments. FIG. 7 is a schematic diagram of a MAC transmitter scheduler which shows executions of transmission commands, according to some embodiments. In some embodiments, FIGS. 6-7 can implement the operations 300, 400, 500 described in embodiments in FIGS. 3-5, respectively. As shown in FIGS. 6-7, these implementations may be hardware-based. For example, in FIG. 6, MAC transmitter scheduler 600 may include a MAC TX controller 602, a MAC TX time and length calculator 604, and background payload scanner 606. The MAC TX controller 602 may be coupled to the MAC TX time and length calculator 604 and the background payload scanner 606 to control the operations thereof.

In some embodiments, the MAC TX time and length calculator 604 may be configured to implement acts 302 (FIGS. 3), 402 (FIG. 4) and determine the total aggregated data unit length as described above in FIGS. 3-5 and further herein. In some embodiments, background and payload scanner 606 may be configured to perform pre-scanning operation such as described in acts 502, 504 (FIG. 5). All of the described components, e.g., 602, 604, 606 may be implemented in hardware, e.g., in one or more IC chips. In some embodiments, the MAC transmitter scheduler 600 may additionally include memory to store station table 608, AMPDU aggregation information structure table 610, and other information 612, which may be used to generate information for transmission. For example, station table 608 may store information that is needed to generate parameters and side band information 620 in transmission commands. In other examples, while fetching MSDUs 616 (an example of MSDUs 616 may include a linked list 220 in FIG. 2), the MAC transmitter scheduler 600 may form MAC headers (e.g., 614) for the aggregation of data units described above and further herein. In some embodiments, payload pointer FIFOs 622 cache the payload buffer pointers (e.g., pointers of data units in the linked list 616) locally to enhance local DMA payload fetch capabilities (e.g., capabilities of processing outstanding transactions, such as processing a number of requests in parallel-processing next request without waiting for the current one to finish). The operation of the MAC transmitter scheduler 600 will be described further in FIG. 7.

FIG. 7 is a schematic diagram of a series of operations 700 that may be implemented in the MAC transmitter scheduler in FIG. 6, according to some embodiments. In a non-limiting execution, the MAC transmitter scheduler fetches the TX command from a command queue in execution (1) 702. A command queue may be associated with a receiver device for which data needs to be transmitted and may have a respective pointer. The TX command may include the multiple MSDUs for transmission (e.g., linked list 220 in FIG. 2, or one of the queues 616 in FIG. 6), where the MSDUs are associated with a particular transmission queue, in some examples.

In FIG. 7, the MAC transmitter scheduler may maintain two memories: internal memory 710 and shared memory 712. Whereas internal memory 710 is used internally for the MAC transmitter scheduler, shared memory 712 may be shared with other components such as the software of the MAC layer. The internal memory 710 and shared memory 712 may each contain a database to store AMPDU aggregation information structure as the result of data unit aggregation. In some embodiments, the MAC transmitter scheduler may execute the TX command to aggregate the MPDUs and store the aggregation information in the internal memory 710, in execution (2) 704.

In non-limiting examples, once the total aggregated data unit length is determined (e.g., in act 302 in FIG. 3 and act 402 in FIG. 4), the MSDUs (e.g., represented by linked list 220 in FIG. 2, or 616 in FIG. 6) may be aggregated into multiple MPDUs in a manner as described above in FIGS. 3-4 (e.g., acts 306 in FIGS. 3, 406 in FIG. 4). As shown in FIG. 7, each row in the database 710 thus stores information for a respective aggregated MPDU, such as a pointer to the MPDU (second column) and the associated MPDU length (third column). Additionally, the database 710 may also include a bit field (first column) to indicate if the corresponding MPDU in a row is successfully transmitted. In some examples, the first column in database 710 may be a BA (block acknowledgment) bitmap. In a variation, the MSDUs may be aggregated into MPDUs in a manner as described above in FIG. 5 (e.g., act 502), and then the total aggregated data unit length is determined by traversing the database 710 (e.g., scanning each row of the database) to determine the accumulated length of respective MPDU lengths of the aggregated MPDUs.

Subsequently, the MAC transmitter scheduler transmits the aggregated MPDUs by traversing the database 710. For example, the MAC transmitter scheduler may construct a wireless frame to include the respective MPDUs in each row of the database 710, and transmit the wireless frame. The MAC transmitter scheduler may update the BA bitmap (first column) based on received ACK signals from the receiver device. When the transmission is finished (e.g., upon issuance of a TX end command), in execution (3) 706, the content of database 710 is copied to shared memory 712, where during execution (4) 708, the AMPDU aggregation information structure in 712 is linked to TX command. For example, the shared memory can be accessed by other components of the MAC layer, e.g., software, via DMA. The MAC layer (e.g., software portion) checks the BA bitmap in the shared memory 712 to determine which data units (e.g., MPDUs) have been sent, and put back those data units which have not been sent to the data packets to be aggregated in the TX command for next transmission.

In some embodiments, the internal memory 710 and shared memory 712 may be configured in different manners to enable efficient execution of the TX commands as described above and further herein. For example, the internal memory may be located proximate to the hardware logics (circuitry), for example, via a memory interface, such as SRAM interface. The shared memory 712, on the other hand, may be proximate to a processor of the MAC layer, for example, using a memory bus. Although hardware is used in FIG. 7 to implement the operations as described in FIGS. 3-5, it is appreciated that high computing performance processor(s) can enable software implementation or a hybrid of software and hardware implementation.

The techniques described in FIGS. 1-7 provide advantages over existing systems. For example, the techniques allow fast determination of the total aggregated data unit length and aggregation of MSDUs to be transmitted. In comparing to pre-calculation methods in existing systems, the techniques as described in the present disclosure determines the data units to be transmitted only upon TXOP becoming available or when it is close to becoming available, thus making the transmission of wireless frames more flexible in light of the wireless network condition changes (e.g., the over the air medium condition, or the capabilities of receiver devices). Further, the MAC layer determines the total aggregated data unit length first before aggregating the data units. This enables the device to send a TX start command with required data length information, then transmit the data units as they are aggregated. Further, because calculations in constructing the wireless frame are performed when the device is permitted to transmit (or when the device is about to be permitted to transmit), no pre-calculations need to be performed and no intermediate data need to be pre-stored, and thus memory space and computing time are saved.

The various methods or processes outlined herein may be implemented in hardware, e.g., one or more ICs, or coded as software that is executable on one or more processors that employ any one of a variety of operating systems or platforms. For example, any part of the methods described above may be implemented in hardware, software, or in combination. Additionally, such software may be written using any of numerous suitable programming languages and/or programming or scripting tools, and also may be compiled as executable machine language code.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

We claim:

1. An apparatus for communication in a wireless network, the apparatus comprising a media access control (MAC) transmitter scheduler configured to perform one or more operations comprising:
in response to determining that a transmission opportunity (TXOP) is available:
determining a total aggregated MAC protocol data unit (MPDU) length based at least on a total number of data bytes to transmit and an MPDU size;
transmitting a transmission (TX) start command using the total aggregated MPDU length;
aggregating a plurality of MAC service data units (MSDUs) to determine one or more MPDUs to be transmitted, wherein a total length of the one or more MPDUs is about to reach the total aggregated MPDU length;
determining a frame including the one or more MPDUs to be transmitted and a padding such that a length of the frame equals the total aggregated MPDU length; and
transmitting a TX command to transmit the frame within an allowed time from when the TXOP is available.

2. The apparatus of claim 1, wherein the MPDU size is one of a maximum MPDU size, an average MPDU size, a minimal MPDU size, or an average MSDU size.

3. The apparatus of claim 1, wherein aggregating the plurality of MSDUs to determine the one or more MPDUs to be transmitted comprises, for each of the one or more MPDUs to be transmitted:
determining a respective MPDU frame including one or more MSDUs and a padding such that a length of the MPDU frame equals the MPDU size.

4. The apparatus of claim 1, wherein the total number of data bytes to transmit is determined based on a maximum number of MPDUs and the MPDU size.

5. The apparatus of claim 4, wherein the total number of data bytes to transmit is determined additionally based on a minimum MPDU start spacing between any two adjacent MPDUs.

6. A method for communicating in a wireless network, the method comprising, at a media access control (MAC) transmitter scheduler:
in response to determining that a transmission opportunity (TXOP) is available:
determining a total aggregated MAC protocol data unit (MPDU) length based at least on a total number of data bytes to transmit and an MPDU size;
transmitting a transmission (TX) start command using the total aggregated MPDU length;
aggregating a plurality of MAC service data units (MSDUs) to determine one or more MPDUs to be transmitted, wherein a total length of the one or more MPDUs is about to reach the total aggregated MPDU length;
determining a frame including the one or more MPDUs to be transmitted and a padding such that a length of the frame equals the total aggregated MPDU length; and
transmitting a TX command to transmit the frame within an allowed time from when the TXOP is available.

7. The method of claim 6, wherein the MPDU size is one of a maximum MPDU size, an average MPDU size, a minimal MPDU size, or an average MSDU size.

8. The method of claim 6, wherein aggregating the plurality of MSDUs to determine the one or more MPDUs to be transmitted comprises, for each of the one or more MPDUs to be transmitted:
determining a respective MPDU frame including one or more MSDUs and a padding such that a length of the MPDU frame equals the MPDU size.

9. The method of claim 6, wherein the total number of data bytes to transmit is determined based on a maximum number of MPDUs and the MPDU size.

10. The method of claim 9, wherein the total number of data bytes to transmit is determined additionally based on a minimum MPDU start spacing between any two adjacent MPDUs.

11. An apparatus for communication in a wireless network, the apparatus comprising a media access control (MAC) transmitter scheduler configured to perform one or more operations comprising:
in response to determining that a transmission opportunity (TXOP) is available:
determining a total aggregated MAC protocol data unit (MPDU) length based at least on an allocated transmission time;
transmitting a transmission (TX) start command using the total aggregated MPDU length;
aggregating a plurality of MAC service data units (MSDUs) to determine one or more MPDUs to be transmitted, wherein a total length of the one or more MPDUs is about to reach the total aggregated MPDU length;
determining a frame including the one or more MPDUs to be transmitted and a padding such that a length of the frame equals the total aggregated MPDU length; and
transmitting a TX command to transmit the frame within the allocated transmission time.

12. The apparatus of claim 11, wherein determining the total aggregated MAC protocol data unit (MPDU) length is additionally based on a modulation and coding scheme (MCS) and bandwidth (BW) associated with the TXOP.

13. The apparatus of claim 11, wherein aggregating the plurality of MSDUs to determine the one or more MPDUs to be transmitted comprises, for each of the one or more MPDUs to be transmitted:
determining a respective MPDU frame including one or more MSDUs and a padding such that a length of the MPDU frame equals an MPDU size.

14. A method for communicating in a wireless network, the method comprising, at a media access control (MAC) transmitter scheduler:
in response to determining that a transmission opportunity (TXOP) is available:
determining a total aggregated MAC protocol data unit (MPDU) length based at least on an allocated transmission time;
transmitting a transmission (TX) start command using the total aggregated MPDU length;
aggregating a plurality of MAC service data units (MSDUs) to determine one or more MPDUs to be transmitted, wherein a total length of the one or more MPDUs is about to reach the total aggregated MPDU length;
determining a frame including the one or more MPDUs to be transmitted and a padding such that a length of the frame equals the total aggregated MPDU length; and
transmitting a TX command to transmit the frame within the allocated transmission time.

15. The method of claim 14, wherein determining the total aggregated MAC protocol data unit (MPDU) length is additionally based on a modulation and coding scheme (MCS) and bandwidth (BW) associated with the TXOP.

16. The method of claim 14, wherein aggregating the plurality of MSDUs to determine the one or more MPDUs to be transmitted comprises, for each of the one or more MPDUs to be transmitted:
determining a respective MPDU frame including one or more MSDUs and a padding such that a length of the MPDU frame equals an MPDU size.

17. An apparatus for communication in a wireless network, the apparatus comprising a media access control (MAC) transmitter scheduler configured to perform one or more operations comprising:
in response to or after starting a backoff counter, at a first time:
aggregating a plurality of media access control (MAC) service data units (MSDUs) to determine one or more MPDUs to be transmitted; and
determining a total aggregated MPDU length based on respective lengths of the one or more MPDUs to be transmitted; and
in response to determining that a transmission opportunity (TXOP) is available, at a second time after the first time:
transmitting a transmission (TX) start command using the total aggregated MPDU length;
determining a frame including the one or more MPDUs to be transmitted; and
transmitting a TX command to transmit the frame within an allocated transmission time.

18. The apparatus of claim 17, wherein the first time is two or fewer slot time intervals prior to the backoff counter expiring.

19. A method for communicating in a wireless network, the method comprising, at a media access control (MAC) transmitter scheduler:
in response to or after starting a backoff counter, at a first time:
aggregating a plurality of media access control (MAC) service data units (MSDUs) to determine one or more MPDUs to be transmitted; and
determining a total aggregated MPDU length based on respective lengths of the one or more MPDUs to be transmitted; and
in response to determining that a transmission opportunity (TXOP) is available, at a second time after the first time:
transmitting a transmission (TX) start command using the total aggregated MPDU length;
determining a frame including the one or more MPDUs to be transmitted; and
transmitting a TX command to transmit the frame within an allocated transmission time.

20. The method of claim 19, wherein the first time is two or fewer slot time intervals prior to the backoff counter expiring.
